(19) United States
(12) Patent Application Publication
(10) Pub. No.: US 2018/0091024 A1
(43) Pub. Date: Mar. 29, 2018

(54) SECONDARY HEAT-TRANSFER MECHANISM OF MOTOR

(71) Applicant: HIWIN MIKROSYSTEM CORP., Taichung City (TW)

(72) Inventors: You-Hua HUANG, Taichung City (TW); Chien-Chih LIN, Taichung City (TW); Chao-Chin TENG, Taichung City (TW); Cheng-Te Chi, Taichung City (TW)

(21) Appl. No.: 15/274,477

(22) Filed: Sep. 23, 2016

(51) Int. Cl. H02K 9/22; H02K 5/20; H02K 41/02

(52) U.S. Cl. CPC H02K 9/22; H02K 41/02; H02K 5/20

(57) ABSTRACT

In a secondary heat-transfer mechanism of a motor provided in the present invention, at least one heat-transfer member is disposed between a stator member and a base to which the stator member is attached, and the heat-transfer member is adjacent to the stator member and the base, so as to conduct heat energy to the heat-transfer member.

### BACKGROUND OF THE INVENTION

### Field of the Invention

The present invention relates to a motor, and more particularly, to a secondary heat-transfer mechanism of a motor that is suitable to be co-constructed with a stator of a motor.

### Description of the Related Art

In the prior art, a pipe is used to form a flow channel around a member to be heat-dissipated, such that heat energy is dissipated while a fluid flows in the flow channel, thereby achieving the heat dissipation effect. For example, as shown in FIG. 1 and FIG. 2, on a base 1 of a secondary side of a linear motor, grooves 3 are disposed along two sides of magnets 2, and two pipes 4 are respectively inserted in the grooves 3, so as to form on the base 1 flow channels in which an external fluid continuously flows, thereby achieving the purpose of heat dissipation; meanwhile, by using notches of the grooves 3, heat energy outside the notches can be radiated on the pipes 4 to be dissipated.

Although it is disclosed in the prior art that the pipes 4 are used to conduct the heat energy of the base 1 by being inserted in and thus directly contacting the base 1, and that radiation of the heat energy is allowed by using the notches of the grooves 3, because the base 1 is generally made of a material such as epoxy resin or polyurethane and thus fails to have a good heat conduction effect, the temperature is not easy to rise but is also difficult to decrease, resulting in that the pipes 4 can only provide a heat conduction effect for a partial region with which the pipes 4 are in direct contact and fail to provide a good heat dissipation effect for the overall structure of the secondary side of the linear motor. Meanwhile, with regard to the technical means of integrally forming the grooves 3 in the base 1, for a member without such grooves, there is no appropriate structure for disposing the pipes 4, which is inconvenient for industrial applications.

### SUMMARY OF THE INVENTION

In view of the above, a main objective of the present invention is to provide a secondary heat-transfer mechanism of a motor, configured to be disposed between a secondary side of the motor and a base to which the secondary side of the motor is attached, in which by using a metallic body with good heat conduction capability of a heat-transfer member, heat energy from surrounding elements adjacent to the metallic body can be conducted to the metallic body, and there is a good assembling structure between the metallic body and the adjacent elements, thereby facilitating manufacture and assembly of the secondary heat-transfer mechanism of a motor.

Therefore, to achieve the above objective, in the secondary heat-transfer mechanism of a motor provided in the present invention, at least one heat-transfer member is disposed between a stator member and a base to which the stator member is attached, and the heat-transfer member is adjacent to the stator member and the base, so as to conduct heat energy to the heat-transfer member.

A first side surface and a second side surface of the metallic body of the heat-transfer member are directly or indirectly attached to the stator member and the base respectively.

Meanwhile, to quickly dissipate the heat energy conducted to the metallic body, the heat-transfer member further includes a flow channel disposed in the metallic body for an external fluid to flow therein, and the flow channel is provided with openings for external communication at two ends of the metallic body, so as to allow the fluid to flow into or be discharged from the flow channel.

Furthermore, to further improve the heat transfer capability, the first side surface and a third surface of the metallic body may be directly or indirectly attached to two sides of the stator member, so as to improve conduction of heat energy by increasing the contact area.

In addition, to reduce the heat energy transferred to the base due to conduction, the heat-transfer member as a spacer is sandwiched between the stator member and the base, such that the stator member and the base are separated from each other to form a gap there-between, whereby transfer of the heat energy is reduced, it is further ensured that the base is free from the impact of the heat energy, and the dimensional stability of the base is ensured.

In this case, to stabilize the bonding of the stator member and the base, the number of the heat-transfer member may be added to two, and the two heat-transfer members are spaced from each other and are respectively disposed between the stator member and the base.

Further, the heat-transfer member is an integrally formed object made of aluminum or an aluminum alloy through extrusion. In specific construction, the metallic body further includes a wing portion and a body portion that are parallel to each other, and the wing portion is between the stator member and the base, and the flow channel is located in the body portion.

The thickness of the wing portion is less than the thickness of the body portion, so as to prevent an excessive increase in a combined height of the stator member and the base, as well as allow the flow channel to have a relatively large inner diameter, such that the inner diameter of the flow channel is substantially increased without excessively increasing the overall height, thereby increasing the flow of the fluid and accelerating heat dissipation.

### BRIEF DESCRIPTION OF THE DRAWINGS

FIG. 1 is a top view of the prior art.

FIG. 2 is a front view of the prior art.

FIG. 3 is an exploded view of an embodiment of the present invention.

FIG. 4 is an assembly view of an embodiment of the present invention.

FIG. 5 is a side view of an embodiment of the present invention.

FIG. 6 is a cross-sectional view of an embodiment of the present invention along the section line 6-6 in FIG. 4.

FIG. 7 is a cross-sectional view of an embodiment of the present invention along the section line 7-7 in FIG. 4.

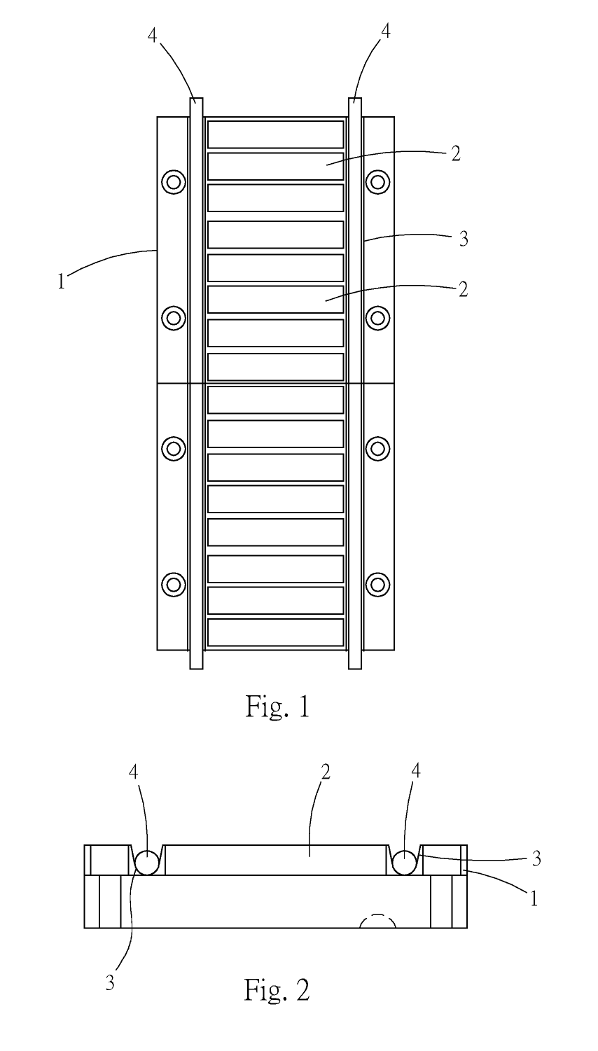

### DETAILED DESCRIPTION OF THE PREFERRED EMBODIMENTS

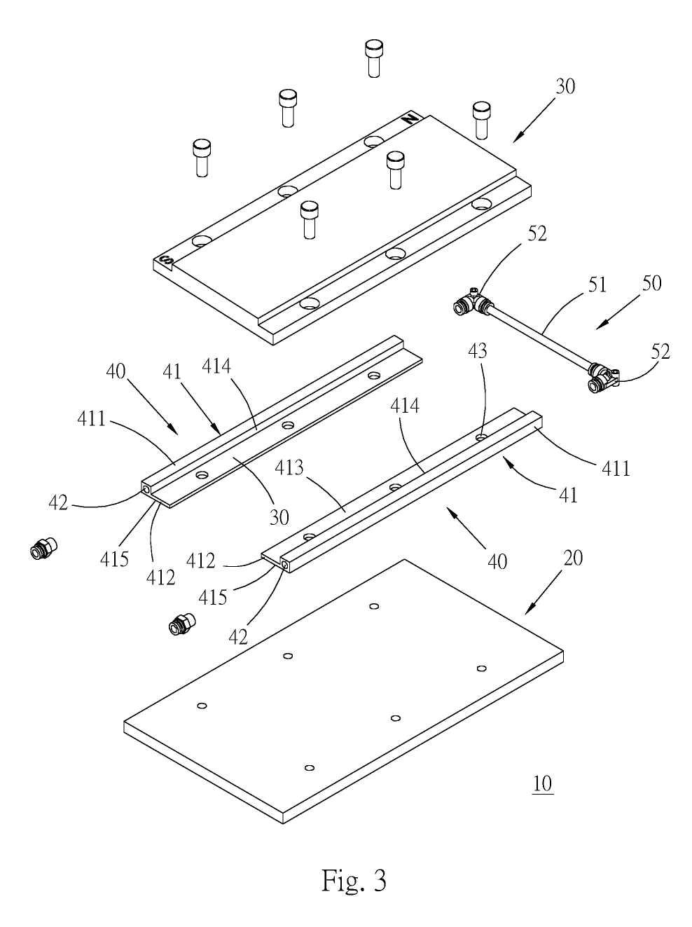

First, referring to FIG. 3, a secondary heat-transfer mechanism of a motor 10 provided in an embodiment of the present invention mainly includes a base 20, a stator member 30, two heat-transfer members 40, and a connection member 50.

The base 20 is an element on which the stator member 30 is disposed, and may be an independent pedestal, a platform for a precision processing machine, or other members, but is not limited thereto. For the convenience of description, a plate-shaped independent pedestal is used as an example for description in this embodiment.

The stator member 30 is a secondary member of a common motor. In this embodiment, a stator of a linear motor is used as an example, and the stator assumes a rectangular plate shape, specific technical details of which fall within the scope disclosed by the prior art and thus are not repeatedly described again.

Each of the heat-transfer members 40 is an integrally formed bar-shaped body made of a metal material such as aluminum or an aluminum alloy through extrusion, and structurally, has a metallic body 41, a flow channel 42 located in the metallic body, and a plurality of through-holes 43 penetrating through the metallic body 41.

Specifically, the metallic body 41 linearly extends to have an appropriate length, and has a body portion 411 and a wing portion 412, where the body portion 411 is formed by extending along the direction of a long axis, the wing portion 412 protrudes from the body portion 411 vertical to the direction of the long axis at one side, and the thickness of the wing portion 412 is less than the thickness of the body portion 411.

The flow channel 42 is located in the body portion 411, and extends along the long axis of the metallic body 41 with openings being formed at two ends of the metallic body 41 respectively.

The through-holes 43 penetrate through the wing portion 412 and are equally spaced from each other.

The connection member 50 has a pipe 51 and two connectors 52 respectively disposed at two ends of the pipe 51.

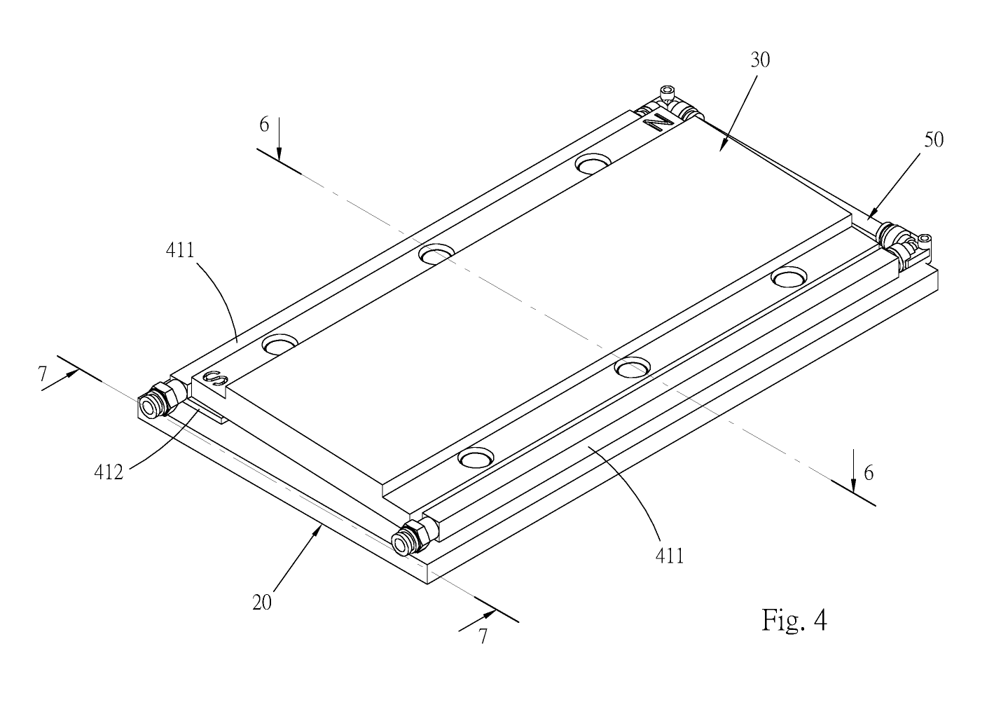

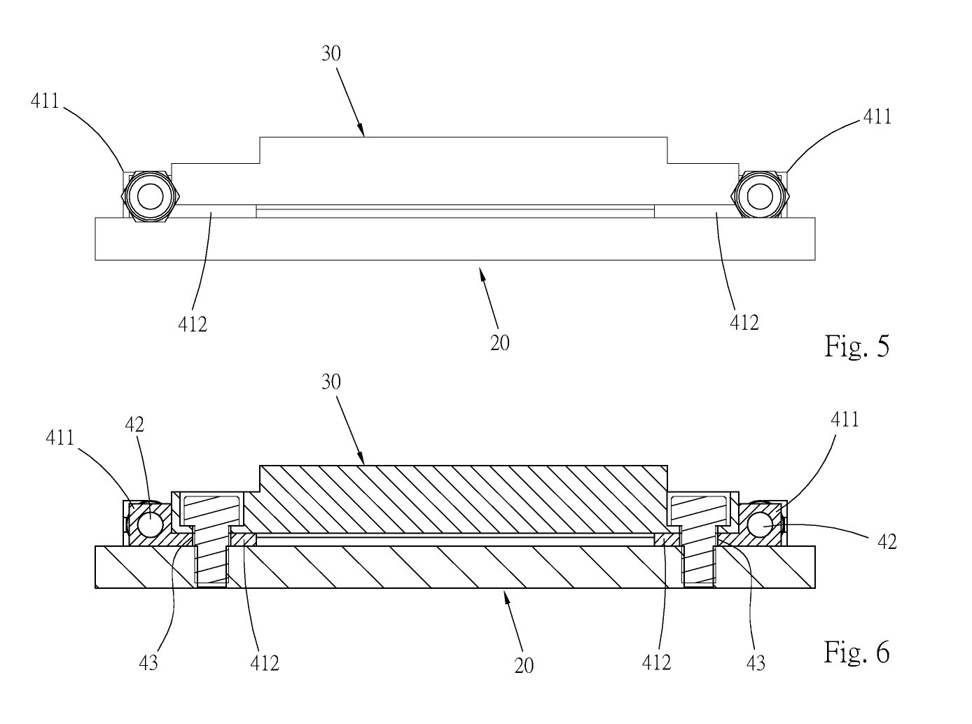

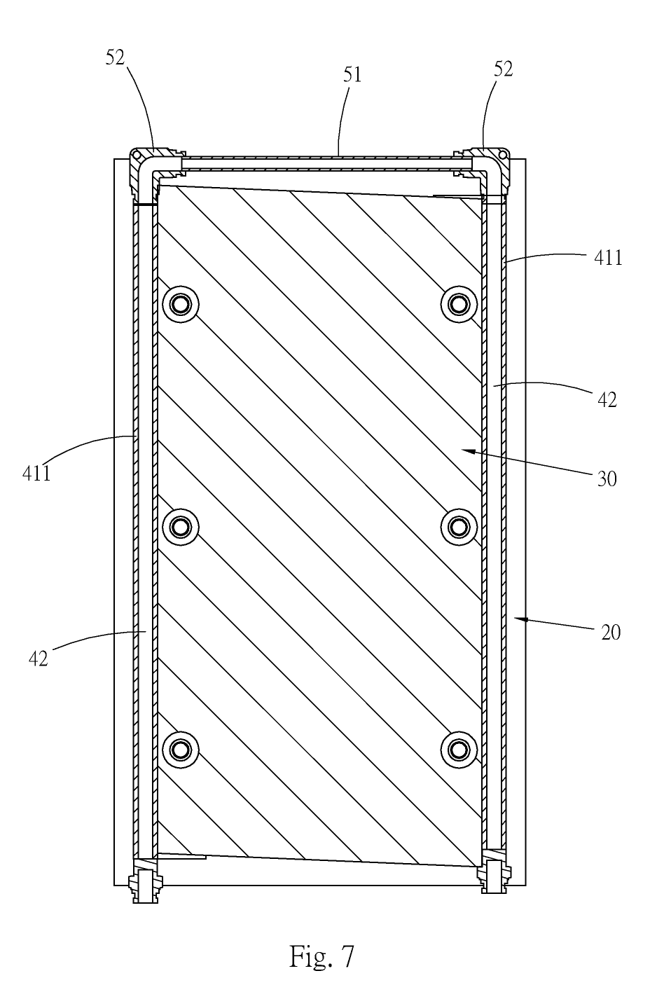

Further referring to FIG. 4 to FIG. 7, in the assembly of the secondary heat-transfer mechanism of a motor 10, the metallic bodies 41 are parallel to each other, and the wing portions 412 are oppositely disposed at two sides of a long axis of the stator member 30, so as to attach first end surfaces 413 at upper sides of the wing portions 412 to an end surface at a bottom side of the stator member 30, and to attach third end surfaces 414 of the body portions 411 that are vertically adjacent to the first end surfaces 413 to an end surface at one side of the long axis of the stator member 30; meanwhile, second end surfaces 415 located at lower sides of the wing portions 412 and the body portions 411 are attached to the base 20, such that the base 20 is separated from the stator member 30 by the wing portions 412 to form a gap there-between with a height being equal to the thickness of the wing portions 412, thereby preventing direct contact of the stator member 30 and the base 20; in addition, the thickness of each wing portion 412 is far less than the thickness of each body portion 411, thereby avoiding an excessive increase in the overall height of the secondary heat-transfer mechanism of a motor 10 as compared with the prior art, which ensures applicability of the secondary heat-transfer mechanism of a motor 10 with respect to the prior art; meanwhile, the body portion 411 with a relatively large thickness allows an increase in an inner diameter of the flow channel 42, thereby allowing a larger amount of a fluid to flow therein.

Moreover, the connectors 52 of the connection member 50 are respectively connected to the metallic bodies 41, such that the flow channels 42 are communicated with each other with the pipe 51 to form a loop in which a fluid can flow.

Further, as the fastening means, a plurality of screws respectively penetrate through the through-holes 43, and two ends of each screw are respectively bonded to the base 20 and the stator member 30, such that a flow channel form that the stator member 30 is suspended over the base 20 by using the heat-transfer members 40 may be stably positioned.

As such, in the heat-transfer mechanism of a motor 10, by means of the particular flow channel form formed between the stator member 30 and the base 20 through each metallic body 41, heat energy is gathered to each metallic body 41, and then is quickly dissipated by providing an external fluid that continuously flows in the loop; by means of the gap formed by using the wing portions 412, direct heat transfer between the base 20 and the stator member 30 is eliminated; with the cooperation of the two aspects above, it can be ensured that the base 20 is dimensionally stable itself and is free from deformation due to heat energy; meanwhile, simplified components thereof further have the effect of easy assembly as compared with the prior art.

What is claimed is:

1. A secondary heat-transfer mechanism of a motor, comprising:
a base;
a stator member, directly or indirectly disposed on the base; and
at least one heat-transfer member, having a metallic body directly or indirectly attached to the base at one side and directly or indirectly attached to the stator member at the other side; and a flow channel, disposed in the metallic body, with openings for external communication being formed at two ends of the metallic body.

2. The secondary heat-transfer mechanism of a motor according to claim 1, wherein the number of the heat-transfer member is two, and the two heat-transfer members are spaced from each other.

3. The secondary heat-transfer mechanism of a motor according to claim 1, wherein at least a part of the metallic body is sandwiched between the stator member and the base.

4. The secondary heat-transfer mechanism of a motor according to claim 3, wherein at least a part of the metallic body separates the stator member from the base.

5. The secondary heat-transfer mechanism of a motor according to claim 4, wherein two side surfaces of the metallic body are respectively attached to two side surfaces of the stator member.

6. The secondary heat-transfer mechanism of a motor according to claim 5, wherein the metallic body has a wing portion, which is the part of the metallic body that is sandwiched between the stator member and the base, one side of the wing portion being attached to one side of the stator member; and a body portion, adjacent to the wing portion, one side of the body portion being attached to the other side of the stator member.

7. The secondary heat-transfer mechanism of a motor according to claim 6, wherein the thickness of the wing portion is less than the thickness of the body portion.

8. The secondary heat-transfer mechanism of a motor according to claim 6, wherein the flow channel is located in the body portion.

9. The secondary heat-transfer mechanism of a motor according to claim 1, wherein the metallic body is made of aluminum or an aluminum alloy through extrusion.

10. The secondary heat-transfer mechanism of a motor according to claim 1, wherein the metallic body extends to have a length, and the openings of the flow channel are located at two ends of a long axis of the metallic body.
